(19) United States
(12) Patent Application Publication
(10) Pub. No.: US 2009/0107733 A1
(43) Pub. Date: Apr. 30, 2009

(54) METHOD AND DEVICE FOR WEIGHING PRODUCTS

(75) Inventor: Hermann Berger, Adenstedt (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: METTLER-TOLEDO GARVENS GMBH, Giesen (DE)

(21) Appl. No.: 11/816,762

(22) PCT Filed: Feb. 2, 2006
(86) PCT No.: PCT/EP06/00915

§ 371 Date: Jul. 25, 2008

(30) Foreign Application Priority Data
Feb. 21, 2005 (DE) 10 2005 007 866.4

(51) Int. Cl. G01G 11/14

(52) U.S. Cl. 177/1; 177/16

(57) ABSTRACT

The invention relates to a check weigher for weighing products during the transport thereof on a weighing belt (2) supported on a weighing cell (7). According to the invention, the parasitic oscillations occurring as products arrive on the weighing belt are suppressed by an initial load (V) applied to the weighing cell (7). The pressure exerted by the initial load is temporarily lifted for the detection of the weight measuring values.

### CROSS REFERENCE TO RELATED APPLICATIONS

The present application is a national phase entry of, and claims priority under 35 U.S.C. § 120 to, International Patent Application No. PCT/EP2006/000915, originally filed Feb. 2, 2006, entitled “Method and Device for Weighing Products” and which designates the United States of America, the entire content and disclosure of which is hereby incorporated by reference in its entirety.

### TECHNICAL FIELD

The present invention relates to methods for weighing products while they are transported across a weighing device, and using the weights from the weighing device measured during transport to determine the final weight of the products. The present invention also relates to devices for implementing the methods.

### BACKGROUND

According to various embodiments of the present invention, products are dynamically weighed while they are transported across a weighing device. This enables a high throughput since, in contrast to a static scale, one does not have to wait for a stable weight value in this dynamic mode. However, numerous transportation-related disturbances act upon the weighing device that generate vibrations and cause corresponding fluctuations in the measured weight values. In particular, the products of the weighing device are placed individually on a conveyor which causes the weighing device to adjust each time. The time required for this adjustment to cease shortens the available waiting time. In a fast weighing process, for example, with more than 600 products per minute, the dwell time of each product on the weighing device is substantially less than 50 milliseconds. A substantial amount of this time is lost for the weighing process since the system has to wait for the adjustment of the weighing device, for example, a weighing cell on which a weighing belt rests that transports the individual products. It becomes increasingly difficult to determine the final weight with sufficient precision during the remaining time which shortens as the number of items increases.

Known scales that work according to the initially cited method (German Patent Pub. No. DE 103 22 504 A1) that are generally termed check weighers, therefore, have a filtering device to obtain a final weight value closely approximating the true weight value from the weight values measured during the dynamic weighing of each product by averaging. In addition, a subsequent product is placed on the weighing belt as the preceding project product leaves the weighing belt. The weighing cell does not readjust as much between sequential products and therefore takes less time to adjust to the product's weight.

However, this does not appreciably eliminate the disturbances caused by the arrival of the products on the weighing device. These disturbances are particularly pronounced when the product weighs a great deal, when it is hard (for example, made of glass), or when it is uneven. In addition, these disturbances are particularly pronounced when the transition between the conveyor (feed belt) and the weighing belt or weighing platform of the weighing device is poorly designed.

The edge steepness and hence the transient recovery time to the target weight upon a sudden load on a weighing cell depends on its natural resonance. The higher the natural resonance frequency of the weighing cell, the steeper the rising edge, and the faster the attainment of the final value. The disadvantage of increasing the rigidity of the weighing cell is that its deformation or deflection decreases, which weakens the measuring signal. A weak measuring signal makes it difficult to measure and evaluate the measured weight values.

Low-frequency revolving parts of the weighing belt and its drive represent another disturbance. An attempt has been made to minimize disturbances and increase the frequencies to enhance filtering over short measuring periods by keeping the diameters small of the rollers on which the weighing belt runs and by balancing the rollers and their motors. Instead of a circulating weighing belt, a weighing platform could be used over which the products are guided solely by the inertia of the products arising from their transport speed, or by active support such as blown air. When the products are sufficiently flat, this platform can be designed as an air cushion. The problems associated with revolving parts do not arise, but there are other disadvantages. When the system starts or stops, the products can collect on the weighing platform. Sloshing liquids, for example, in glasses or aerosol cans, generate a particularly low-frequency disturbance when they slow down on the weighing platform. A weighing platform designed as an air cushion poses almost no disadvantages, but its use is limited to very flat products such as folded boxes and cartons.

In providing an explanatory example of the situation that arises when the products arrive on a circulating weighing belt as well as a fixed weighing platform, it is assumed that glasses with an uneven base weighing more than 3,000 grams should be weighed at a rate of 1,000 items per minute. When said glass items are transferred from the feed belt to the weighing belt or platform, the weighing device providing support receives a strong impact due to the poor transfer at high speed, the uneven glass base, and the heavy weight which causes said weighing device to wobble and vibrate. Before the weighing device has calmed down and a sufficiently undisturbed weighing process can occur, the glass leaves the weighing belt or platform which again causes disturbances.

### BRIEF DESCRIPTION OF THE DRAWINGS

FIG. 1 is a schematic of an exemplary check weigher in accordance with the present invention;

FIG. 2 is a schematic of an exemplary device for mechanically generating an initial load in accordance with the present invention;

FIG. 3 is a schematic of an exemplary electrodynamic device for generating an initial load by Lorentz force in accordance with the present invention;

FIG. 4 is a schematic of an exemplary device for electrodynamically generating an initial load by reluctance force in accordance with the present invention;

FIG. 5 is a schematic of an exemplary device for electrodynamically generating an initial load as a difference between two opposing reluctance forces in accordance with the present invention; and

FIG. 6 is a schematic of another embodiment of a device for electrodynamically generating an initial load by reluctance force in accordance with the present invention.

### DETAILED DESCRIPTION OF EMBODIMENTS OF THE INVENTION

In light of the foregoing problems, embodiments of the present invention are directed to methods and devices for reducing the disturbance caused by transferring products to a conveying section.

In accordance with the present invention, the foregoing problems may be solved by preloading the weighing device, and eliminating the load while measuring the weight values used to determine the end weight.

In an exemplary method according to the present invention, products are individually added to the transport section formed by the weighing device. While the product is arriving on the weighing device, the weighing device is pretensioned by the initial load with a weight approximating the target weight of the product. This prevents the disturbances that otherwise arise when the products arrive. When the product is sufficiently or completely resting on the weighing device, the initial load is removed, and the weighing device only detects the weight corresponding to the product. As soon as a sufficient number of weight values have been measured to determine the final weight of the product (a single measured weight per product is theoretically sufficient), i.e., a sufficient measuring time has passed, the initial load is applied again. The load on the weighing device thereby remains at the anticipated weight of the subsequent product. The weighing device is therefore not stimulated to vibrate significantly when the next product arrives. When the product is completely or nearly lying on said weighing device, the initial load for determining the measured weight value is removed, and the weighing device only experiences a change in the load corresponding to the deviation in weight between the initial load corresponding to the target weight value, and the actual weight. In practice, this means that the speed of the weighing device no longer depends on the load and is not as dependent on the natural resonance of the weighing device. This increases precision even at higher weights and speeds.

A device for weighing products suitable to solve the problem comprising a weighing device, a conveying device for transporting the products across the weighing device, and an evaluation device to determine the final weights of the products using the measured weight values from the weighing device determined while transporting said products is characterized by a preloading device that can load the weighing device with an initial load, and the initial load is released while measuring the weight values used to determine the final weight values.

The weighing device has in particular a weighing cell and a transport section resting on it that individually transports the products to be weighed. This transport section whose own weight is accommodated can be designed as a driven, circulating weighing belt that actively transports the products. Alternately, the transport section can be designed as a weighing platform that does not convey items. Products are transported over it, for example, by the inertia of said products from their previous transportation movement. The weighing cell can be based on known transducer principles, for example, the strain gauge principle, the vibrating wire principle, electromagnetic load compensation principle, capacitive principle or the gyroscope principle.

The value of the initial load is preferably selected as a function of the weight of the products. The closer the value selected for the initial load to the actual weight of the product, the smaller the load change and hence the disturbance. This can be advantageously realized by using the determined final weight value of the product before the product to be weighed as the value for the initial load for a product to be weighed. This embodiment exploits the fact that products in a series to be weighed are adjusted to a specific target weight, and their actual weights only differ from each other by comparatively small tolerance deviations that primarily arise from an avoidable imprecision in filling and the associated tolerance fluctuations in the filling weight. The final weight value determined for the preceding product while transporting it generally offers a very good approximation of the final weight value to be expected for the following product, and thereby provides a suitable value for the initial load.

However, in practice, items with irregular weight deviations arise in the product flow fed to the check weigher. For example, a filling system can experience malfunctions that cause completely empty or only slightly filled packages to enter the product flow. On the other hand, occasionally very heavy, different products enter the transported flow. In this case, it would be disadvantageous to use the final weight of such a bad product as the value of the initial load for a subsequent, correct product. For this reason, an advantageous embodiment of the method according to the invention provides that the final weight value determined for the previous product is compared with a predetermined tolerance and, when it exceeds said tolerance, an initial load value that does not exceed the tolerance is used instead of the final weight value. For example, this tolerance can be specified as the lowest final weight value where the product is rejected as incorrect when the weighed value falls below said tolerance. Likewise, the tolerance can be alternately or simultaneously specified as the greatest final weight value where the product is rejected as incorrect when said tolerance is exceeded. When the weighing device is determining the final weight and identifies an irregular product that exceeds the tolerance, the initial load value not exceeding the tolerance is immediately applied to said weighing device to prevent excessive adjustment.

One possible embodiment of the method according to invention is to mechanically generate the initial load. In regard to the device, this is easily realized by providing the preloading device with a tensioning element between the weighing device and a stationary abutment, said tensioning element being tensioned with an initial load value below the weight of the products and relaxable when the load on the weighing device exceeds the initial load. The effect of the preloading device is automatically removed when the weighing device experiences a load exceeding the initial load value when the product arrives on said weighing device, and the tensioning element is relaxed by the increasing load on the weighing device. When the product leaves the weighing device, the load on said weighing device decreases until the tensioning element is fully tensioned and thereby exerts the predetermined initial load. Of course, the tensioning element can also be designed to exert the initial load by tension, pressure or torsion. Instead of generating a mechanical initial load, a cylinder/piston unit can be used to pneumatically or hydraulically actuate the desired initial load on the weighing device.

In a preferred embodiment of the method according to the invention, the initial load is generated electrodynamically. This has the particular advantage that the generation of the initial load can be electrically or electronically controlled and regulated.

In this regard, a possible embodiment of the method according to the invention provides that the initial load is generated by the Lorentz force exerted by an electrically charged coil in a magnetic field. In regard to the device, the preloading device can have an electrically chargeable coil located in an air gap of a magnet whose Lorentz force acting on it forms the initial load. The coil is usefully coupled to a load absorbing or load transmitting element of the weighing device, whereas the magnet is fixed. The Lorentz force forming the initial load has a linear relationship with the current flowing through the coil, which allows it to be easily controlled and regulated. The level of the attainable initial load is restricted, though.

Contrastingly, an alternative embodiment of the method according to the invention provides that the initial load is generated by a reluctance force exerted on an armature in a magnetic circuit. In regard to the device, this can be realized by providing the preloading device with a magnetic circuit consisting of a magnet yoke wound with an electrically chargeable exciter winding and a magnet armature, and the reluctance force acting thereupon forms the initial load. The magnet armature is usefully mechanically coupled to a load absorbing or load transferring element of the weighing device, and the magnetic yoke is contrastingly fixed. The reluctance force forming the initial load is proportional to the inverse square of the air gap between the magnet armature and magnet yoke and is quite high when the air gap widths are small. However, the reluctance force is very nonlinear. In particular, it can be useful to provide a distance sensor that measures the deflection of the armature in reference to the magnet yoke, and its path signal is used to control the current flowing through the exciter winding.

Another advantageous alternative is to generate the initial load by the resulting reluctance force exerted on an armature in two opposing magnetic circuits. With such a corresponding device, the preloading device has two opposing magnet yokes that each are wound with a chargeable exciter winding, and an intermediate magnet anchor that forms a magnetic circuit with each of the two magnet yokes and whose reluctance force acting thereupon forms the initial load. In this case, the opposing reluctance forces of the two magnet yokes act on the magnet armature. The pretension exerted by the magnet armature then corresponds to the resulting essentially linear differential force.

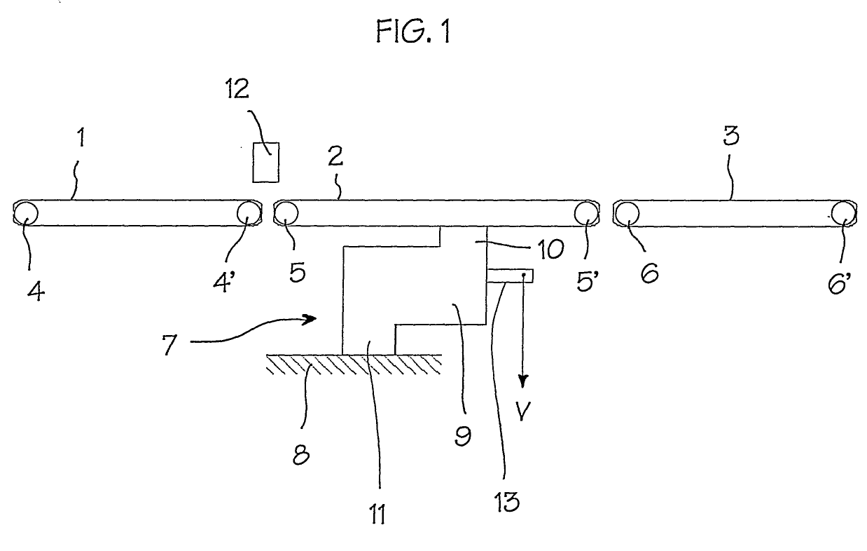

Viewed along a horizontal vanishing line, the check weigher schematically illustrated in FIG. 1 comprises a feed belt 1, a weighing belt 2, and a removal belt 3. The three belts 1, 2, 3 revolve in the same direction and at the same speed on horizontally-spaced rollers (4 and 4′, 5 and 5′, 6 and 6′), of which rollers 4′, 5′, and 6′ are driven by electric motors (not shown). These electric motors are controlled to ensure that the same transport speed is set for all three belts 1, 2, 3. The weighing belt 2 is supported by a weighing cell 7 affixed to a stationary support 8 of the check weigher.

In FIG. 1, the weighing cell 7 is shown, for example, as a strain gauge weighing cell comprising a flexible body 9 that bends under a load between the load absorbing zone 10 supporting the weighing belt 2 and its fixing zone 11 for holding the support 8. The flexible body is provided with strain gauges on its bending zones by means of which an electrical signal corresponding to the active load can be generated in a familiar manner. This electrical signal is scanned in a familiar manner at a predetermined frequency of, for example, 1200 Hz by an evaluation device (not shown). The evaluation device uses these scanning values to form the measured weight values corresponding to the respective load.

The check weigher checks if the products to be weighed such as packages, bags, glasses, etc. maintain a specified target filling weight within a specified tolerance. The weighing belt 2 receives the individual products to be weighed by the feed belt 1 at its input end in relation to the direction of conveyance. At this input-side end, there is a sensor device 12 in the form of a light barrier. This sensor device 12 detects the passage of the front edge or rear edge of the product when it passes through the light barrier in the direction of conveyance. A tachogenerator (not shown) is provided on at least one of the electric motors for driving the feed belt 1, weighing belt 2 and removal belt 3, said tachogenerator generating a sequence of pulses at an impulse frequency proportional to the rotation of the driveshaft of this electric motor. The number of pulses by this tachogenerator within a unit of time therefore corresponds to a transport section traversed by each of the belts 1, 2, 3 as they circulate within this unit of time.

The weighing device can be provided with an initial load V at the side where the load is introduced. This is illustrated in FIG. 1 by a vector arrow representing initial load V that acts upon an arm 13 of the flexible body 9 at the load absorbing side. This initial load pretensions the weighing device at a weight approximately corresponding to the anticipated final weight of the individual products. This pretension suppresses parasitic vibration in the weighing belt 2 when the products supplied on the feed belt 1 arrive on the weighing belt 2. The output signals of the sensor device 12 and of the tachogenerator are used by the evaluation device to determine the position of the product in reference to the input-side end of the weighing belt 2. When a sufficient length of the product or the entire product lies on the weighing belt 2, the load on the weighing device exerted by the initial load is released. The weight values measured by the weighing device after this load is released are solely generated by the product lying on the weighing belt 2 and are used by the evaluation device to determine the final weight value of the respective product. In principle, a single such measured weight value can be used as the final weight value. Preferably, however, the final weight value is formed by filtering as an average of a plurality of measured weight values determined while the product is being transported on the weighing belt 2. As soon as the final weight value is formed, the initial load is reapplied. The value of the initial load is preferably selected so that it corresponds to the previously formed final weight value.

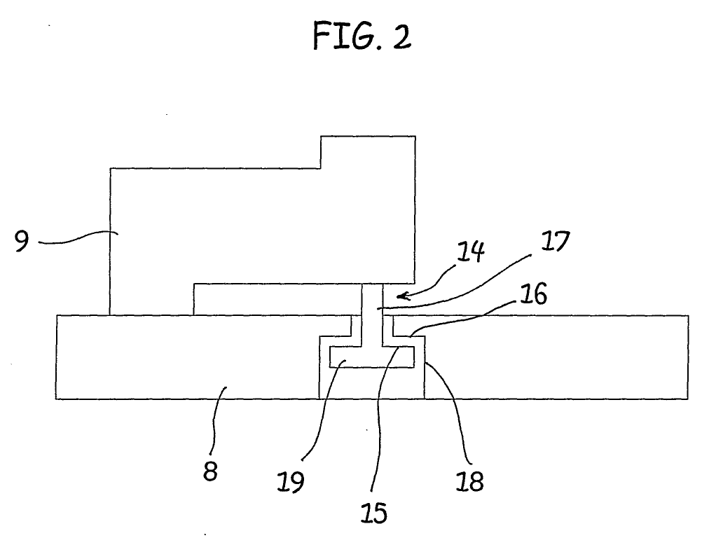

FIG. 2 (that only shows a section of the weighing device of the check weigher) shows a mechanical process to generate the initial load. A tension element 14 is anchored in the flexible body 9 of the weighing cell at the load absorbing side, said tension element extending in the load-absorbing device of the weighing cell to the stationary support 8 of the flexible body 9. A shoulder 15 perpendicular to the load-absorbing device can contact a complementary shoulder 16 of the support 8. In FIG. 2, the tension element 14 is designed as a threaded bolt that can be screwed into a threaded bore of the flexible body 9, the shaft 17 of said threaded bolt penetrating with play a stepped bore 18 of the support 8, and the head 19 of said threaded bolt neighboring the shoulder 15 for contacting the complementary shoulder 18 of the support 8 formed in the stepped bore 18. The threaded bolt is screwed into the flexible body 9 until the tension between the flexible body 9 and support 8 generates an initial load whose value is below the anticipated weight of products. Consequently, the shoulders 15, 16 separate from each other, and the load generated by the initial load is released when the weighing device is loaded with a product. When the product leaves the weighing belt, the load that is exerted by the product on the weighing device ends along with the deflection of the flexible body 9 corresponding to this load. The shoulders 15, 16 contact each other, and the predetermined initial load is automatically restored.

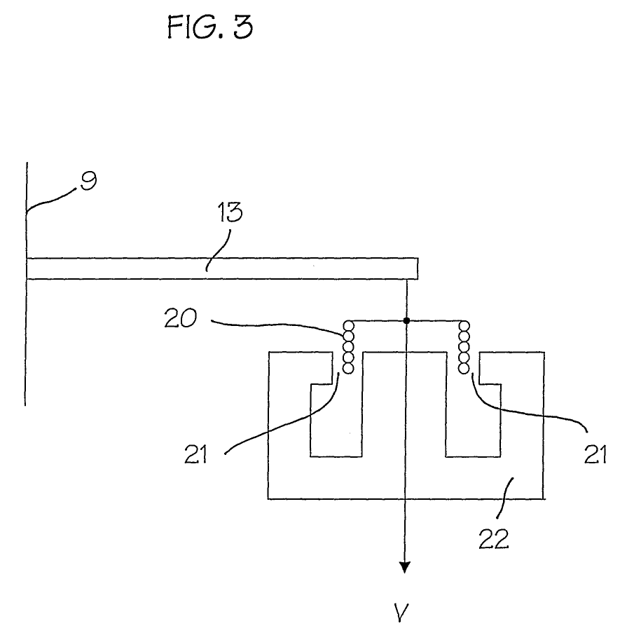

The initial load is generated electrodynamically in FIG. 3 in which only a part of the load-absorbing side of the flexible body 9 and the arm 13 extending from it are sketched. To this end, a plunger coil 20 connected to the arm 13 is located in an annular air gap 21 of a fixed magnet 22. By appropriately controlling or regulating the current flowing through the plunger coil 20, the Lorentz force arising in the plunger coil 20 is adjusted to the new value desired for the initial load.

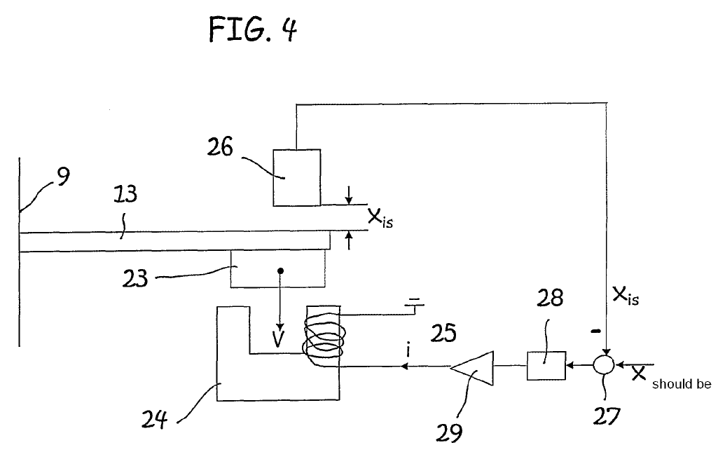

The schematic representation of the flexible body 9 and its arm 13 in FIG. 4 corresponds to the depiction in FIG. 3. In FIG. 4, the initial load is also generated electrodynamically, but it arises via the reluctance force that is generated by a magnet armature 23 connected to the arm 13 in the magnetic circuit of a U-shaped, fixed magnet yoke 24 that is wound with an exciter winding 25. By appropriately controlling or regulating the current flowing through the exciter winding, the reluctance force is adjusted to the desired value for the initial load V.

A suitable control circuit for setting this initial load is sketched in FIG. 4. The deflection of the flexible body 9 corresponding to the desired initial load V is supplied to this control circuit as a set point x_{set point}. The actual value x_{actual} of the deflection is detected by a distance sensor 26 and returned to a subtraction element 27 in which the control deviation is formed as the difference between x_{set point} and x_{actual}. This control difference is used to control a PID controller 28 whose output supplies the manipulated variable for a power amplifier 29 that correspondingly controls the current i flowing through the exciter winding 25.

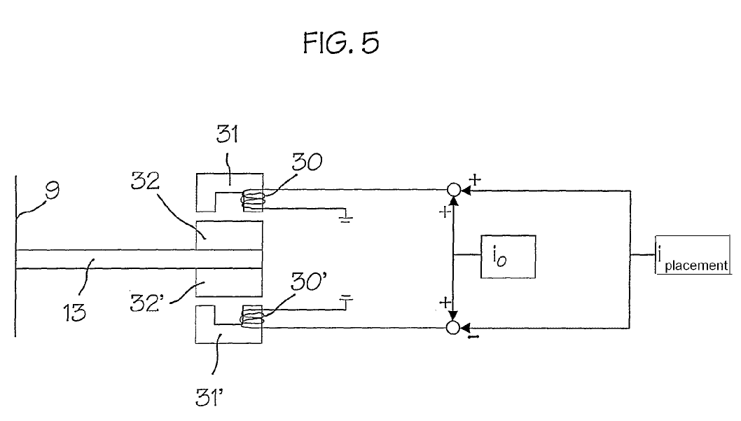

In the exemplary embodiment shown in FIG. 4, the initial load V is essentially inversely proportional to the square of the deflection x_{actual}. To avoid this strongly nonlinear relationship, two magnet yokes 31, 31′ that are each provided with an exciter winding 30, 30′ are arranged opposite each other in the exemplary embodiment in FIG. 5 so that the reluctance forces oppose each other that are exerted by these two magnet yokes 31, 31′ on the intermediate two-part magnet armature, one part 32 of which is within a magnetic circuit of magnet yoke 31, and the second part 32′ is in a magnetic circuit of magnet yoke 31′. The resulting reluctance force is largely linearized, which is exerted on the two parts 32, 32′ of the arm 13 of the flexible body 9 bearing the magnet armature. The two exciter winding 30, 30′ in to FIG. 5 are initially excited with equivalent currents iₒ flowing in the opposite direction. This initial excitation causes the reluctance forces acting on the magnet armatures 32, 32′ to form an equilibrium, and the resulting reluctance force is essentially zero. The initial excitation circuit is overlapped by the controlled flow iplacement that adjusts the resulting reluctance force to a value corresponding to the desired initial load.

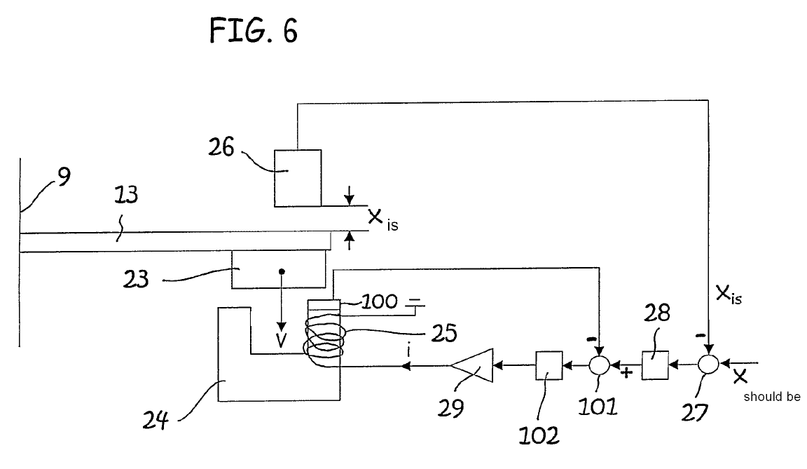

The nonlinear behavior that tends to cause instability can also be counteracted by an additional flow control depending on the flow measurement. FIG. 6 shows an embodiment in which this flow control is installed in the embodiment shown in FIG. 4. In FIG. 6 where the parts corresponding to FIG. 4 are provided with the same reference numbers as in FIG. 4, a Hall sensor detects the predominant flux density in the magnetic circuit. The output signal of the Hall sensor 100 corresponding to the flux density is fed to the inverting input of a subtraction element 101, and the distance regulator 28 is connected to its non-inverting input. The output signal of the subtraction element 101 controls a flux regulator 102 whose output is connected to the input of the power amplifier 29. The flux regulator 102 thereby forms the inner control loop of a cascade control which allows the magnetic force acting on the magnet armature 24 to be finely and very precisely adjusted. Of course, such a flux control loop could also be provided with the differential arrangement shown in FIG. 5 even though it is less necessary there.

With this embodiment based on the electrodynamic generation of an initial load, controlling or regulating the current in the plunger coil or in the exciter coils provides an excellent opportunity to accordingly set the time for the falling curve or rising curve to minimize the fluctuation range of the measured weight values.

In addition, the electrodynamic generation of the initial load makes it easier to choose a suitable value for the initial load in irregular cases where, for example, the malfunction of a filling device causes empty or near empty packages to enter the product flow, or where improperly altered products arise whose weight greatly exceeds the product series to be monitored. As soon as it is found that a predetermined tolerance is not maintained while determining the final weight value, an initial load value compatible with the tolerance is set instead of this irregular final weight value so that the following product arriving on the device causes a minimal difference in the load. Hence, in irregular cases, the weighing device thereby maintains an initial load that enables the subsequently arriving regular product to only cause a minimum disturbance.

1-18. (canceled)

19. A method for weighing products while they are transported over a weighing device, comprising:
applying an initial load to the weighing device;
transporting a first product over the weighing device;
measuring at least one measured weight value of the first product during said transporting;
relieving the initial load during said measuring the at least one measured weight value; and
determining a final weight value of the first product using the at least one measured weight value.

20. The method of claim 19, wherein the initial load is a function of an expected weight of the first product.

21. The method of claim 20, wherein a final weight value determined for a second product preceding the first product is used as the weight of the initial load for the first product.

22. The method of claim 21, further comprising:
comparing the final weight value determined for the second product with a predetermined tolerance; and
if the predetermined tolerance is exceeded, the initial load is a value not exceeding the tolerance instead of the final weight value determined for the second product.

23. The method of claim 19, wherein the initial load is generated mechanically.

24. The method of claim 19, wherein the initial load is generated electrodynamically.

25. The method of claim 24, wherein the initial load is generated by a Lorentz force exerted on an electrically charged coil in a magnetic field.

26. The method of claim 24, wherein the initial load is generated by a reluctance force exerted on an armature in a magnetic circuit.

27. The method of claim 24, wherein the initial load is generated by a reluctance force exerted on an armature in two opposing magnetic circuits.

28. The method of claim 19, wherein the initial load is released based at least in part on a decreasing load curve including a curve over time minimizing a fluctuation range of the at least one measured weight value.

29. The method of claim 19, wherein the initial load is created based at least in part on an increasing load curve including a curve over time minimizing the fluctuation range of the at least one measured weight value.

30. A device for weighing products comprising:
a weighing device configured to measure at least one weight value of a first product;
a conveying device for transporting the first product over the weighing device;
an evaluation device configured to determine a final weight value of the first product using the measured weight values; and
a preloading device configured to pre-load the weighing device with an initial load and to release the initial load while the weighing device is measuring the at least one weight value of the first product.

31. The device of claim 30, wherein the preloading device includes a tensioning element disposed between the weighing device and a stationary abutment, the tensioning element being configured to be tensioned by a value of the initial load, the value being less than an expected weight of the first product, the tensioning element being further configured to be tensioned by a value less than the initial load when the weighing device has a load exceeding the initial load.

32. The device of claim 30, wherein the preloading device includes a chargeable coil in an air gap of a magnet, and wherein a Lorentz force acting on the coil forms the initial load.

33. The device of claim 30, wherein the preloading device includes two opposed magnet yokes including a chargeable exciter winding and an intermediate magnet armature forming a magnetic circuit including a reluctance force forming the initial load.

34. The device of claim 30, wherein the preloading device includes a magnetic circuit having a magnet yoke including a chargeable exciter winding and a magnet armature including a reluctance force forming the initial load.

35. The device of claim 34, further comprising a control loop for controlling charging of the exciter winding based at least in part on a difference between a setpoint corresponding to a desired value of the initial load and a measured value of the initial load.

36. The device of claim 35, wherein the control loop includes feedback for measuring a signal corresponding to a flux density of the magnetic circuit.
